(19) United States
(12) Patent Application Publication
(10) Pub. No.: US 2017/0312169 A1
(43) Pub. Date: Nov. 2, 2017

(54) Weight Plate Loadable Body Tempering Device

(71) Applicants: Robert Polenik, Rock Hill, SC (US); Joseph Polenik, Clymer, PA (US)

(72) Inventors: Robert Polenik, Rock Hill, SC (US); Joseph Polenik, Clymer, PA (US)

(21) Appl. No.: 15/274,186

(22) Filed: Sep. 23, 2016

Related U.S. Application Data
(60) Provisional application No. 62/329,759, filed on Apr. 29, 2016.

(51) Int. Cl. A61H 15/00

(52) U.S. Cl. CPC A61H 15/00; A61H 2015/0014

(57) ABSTRACT

A weight plate loadable body tempering device includes and outer housing, a shaft, and a divider. The outer housing has a left opening and a right opening separated by a middle. The shaft extends through a central axis of the outer housing from approximately a distal end of the left opening to approximately a distal end of the right opening. The divider is positioned inside the outer housing at the middle. The divider positions the shaft on the central axis of the outer housing and separates the left opening from the right opening thereby creating a left weight chamber and a right weight chamber.

### CROSS-REFERENCE TO RELATED APPLICATIONS

This application claims benefit to U.S. Provisional Patent Application No. 62/329,759, filed on Apr. 29, 2016, which is incorporated by reference in its entirety.

### FEDERALLY SPONSORED RESEARCH OR DEVELOPMENT

None

### PARTIES TO A JOINT RESEARCH AGREEMENT

None

### REFERENCE TO A SEQUENCE LISTING

None

### BACKGROUND OF THE DISCLOSURE

### Technical Field of the Disclosure

The instant disclosure generally relates to body tempering devices. More particularly, the instant disclosure relates to a weight plate loadable body tempering device.

### Description of the Related Art

Body tempering is performed by rolling heavy pipe like devices over one's body. As the heavy pipe is rolled over the body, it is believed to break apart muscle adhesions and squeeze blood and water from the treated area. Once the heavy pipe like device is removed from the treated area, the user's heart will flush the treated area with new blood. This new blood may rejuvenate the muscle tissue in the treated are thereby improving healing of the muscle tissue. As a result, body tempering is believed to help prevent hernias, tears, tweaks, muscle ruptures and protect against trauma, by allowing the body to work independently of muscle adhesions. As examples, body tempering may be used by athletes to help in strength training and recovery.

Fixed weight pipe like body tempering devices are known. Currently, these pipe like body tempering devices are fixed weight devices, meaning that each pipe like device has a certain fixed weight. As different weights/sizes are needed for various areas of the body and for different sizes and shapes of people, these known fixed weight body tempering devices require the user to purchase a variety of different pipe like devices for a variety of different weights to achieve maximum results. In addition, these current designs of body tempering devices are semi-permanent requiring sand or cement to be used as a weight. Further, as different areas of the body require different size and/or weights of pipe like body tempering devices, these current semi-permanent body tempering devices are not quickly changeable in treatment areas and/or are not quickly adjustable.

The instant disclosure of a weight plate loadable body tempering device is designed to address at least some aspects of the problems discussed above.

### SUMMARY

Briefly described, in a possibly preferred embodiment, the present disclosure overcomes the above-mentioned disadvantages and meets the recognized need for such a device by providing a weight plate loadable body tempering device, system and method. The instant disclosure of a weight plate loadable body tempering device, system and method may provide an adjustable body tempering device and system that allows methods of adjustable body tempering.

In one aspect, the instant disclosure embraces a weight plate loadable body tempering device with an outer housing having a left opening and a right opening separated by a middle. A shaft may extend through a central axis of the outer housing from approximately a left distal end of the left opening to approximately a right distal end of the right opening. A divider may be positioned inside the outer housing at the middle. The divider may position the shaft on the central axis of the outer housing. The divider may also separate the left opening from the right opening thereby creating a left weight chamber and a right weight chamber.

One feature of the weight plate loadable body tempering device and system may be the inclusion of at least one pair of weight plates. The weight plates may be configured to fit inside the outer housing and slide on the shaft. Each pair of the at least one pair of weight plates may include a left weight plate and a right weight plate. The left weight plate may be loadable on the shaft in the left weight chamber of the outer housing. The right weight plate may be loadable on the shaft in the right weight chamber of the housing. Whereby, the weight plate loadable body tempering device may have an adjustable total weight by adjusting the number and/or size of the at least one pair of weight plates loaded in the left and/or right weight chambers.

In select embodiments of the weight plate loadable body tempering device and system, each left weight plate may be the same size and/or weight of the corresponding right weight plate for each pair of the at least one pair of weight plates. By making the left weight plate the same size and/or weight with the corresponding right weight plate, the weight plate loadable body tempering device may be balanced.

Another feature of the weight plate loadable body tempering device and system may be the inclusion of a pair of clamps for holding the weight plates inside outer housing of the weight plate loadable body tempering device. The pair of clamps may include a left clamp and a right clamp. The left clamp may be configured to slide on the shaft in the left opening of the outer housing for holding the loaded left weight plates in the left weight chamber of the outer housing. The right clamp may be configured to slide on the shaft in the right opening of the outer housing for holding the loaded right weight plates in the right weight chamber of the outer housing. In select possibly preferred embodiments, the clamps may be compression clamping devices.

Another feature of the weight plate loadable body tempering device and system may be the inclusion of a pair of spacers for spacing the weight plates from the middle inside the weight plated loadable device. The pair of spacers may include a left spacer and a right spacer. The left spacer may be configured to slide on the shaft in the left opening of the outer housing prior to loading the left weight plates for spacing the subsequently loaded left weight plates from the middle in the left weight chamber. The right spacer may be configured to slide on the shaft in the right opening of the outer housing prior to loading the right weight plates for spacing the subsequently loaded right weight plates from the middle in the right weight chamber. In select, possibly preferred embodiments, the spacers may be cylinders.

Another feature of the weight plate loadable body tempering device and system may be that the outer housing may have a substantially circular cross-section.

In another aspect, the instant disclosure embraces a method of adjustable body tempering. The method of adjustable body tempering may utilize any of the various embodiments of the weight plate loadable body tempering device and system, as shown and/or described herein. The method of adjustable body tempering may generally include the step of providing the weight plated loadable body tempering device/system in any of the various embodiments shown and/or described herein, and the step of adjusting a total weight of the weight plate loadable body tempering device by adjusting the amount and/or size of weight plates loaded in the left and right weight chambers.

In select embodiments of the method of adjustable body tempering, when the weight plate loadable body tempering system includes the pair of clamps, the method of adjustable body tempering may further include the step of securing the weight plates loaded in the left and right weight chambers via the left and right clamps, respectively.

In select embodiments of the method of adjustable body tempering, when the weight plate loadable body tempering system includes the pair of spacers, the method of adjustable body tempering may further include the step of spacing the subsequently loaded weight plates loaded in the left and right weight chambers from the middle via the left and right spacers by sliding the spacers onto the shaft in the left and right weight chambers prior to loading the weight plates.

### BRIEF DESCRIPTION OF THE DRAWINGS

The present apparatuses, systems and methods will be better understood by reading the Detailed Description with reference to the accompanying drawings, which are not necessarily drawn to scale, and in which like reference numerals denote similar structure and refer to like elements throughout, and in which:

FIG. 1 is a schematic perspective view of the weight plate loadable body tempering device according to select embodiments of the instant disclosure;

FIG. 2 is a schematic cross-sectional view of the weight plate loadable body tempering device of FIG. 1;

FIG. 3 is a schematic disassembled perspective view of the weight plate loadable body tempering device of FIG. 1;

FIG. 4 is a schematic cross-sectional view of the weight plate loadable body tempering device of FIG. 1 with a spacer included in both the left and right weight chambers;

FIG. 5 is a schematic disassembled perspective view of the weight plate loadable body tempering device of FIG. 1 with a spacer included in both the left and right weight chambers;

FIGS. 6A, 6B, 6C, 6D, and 6E are schematic environmental views with the weight plate loadable body tempering device of FIG. 1 being rolled down the body of a patient from the calves (FIG. 6A), to resting between the hamstrings and calves (FIG. 6B), to the glutes (FIG. 6C) to the lower back (FIG. 6D), and to the upper back (FIG. 6E); and

FIG. 7 is a flow diagram of the method of adjustable body tempering according to select embodiments of the instant disclosure.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

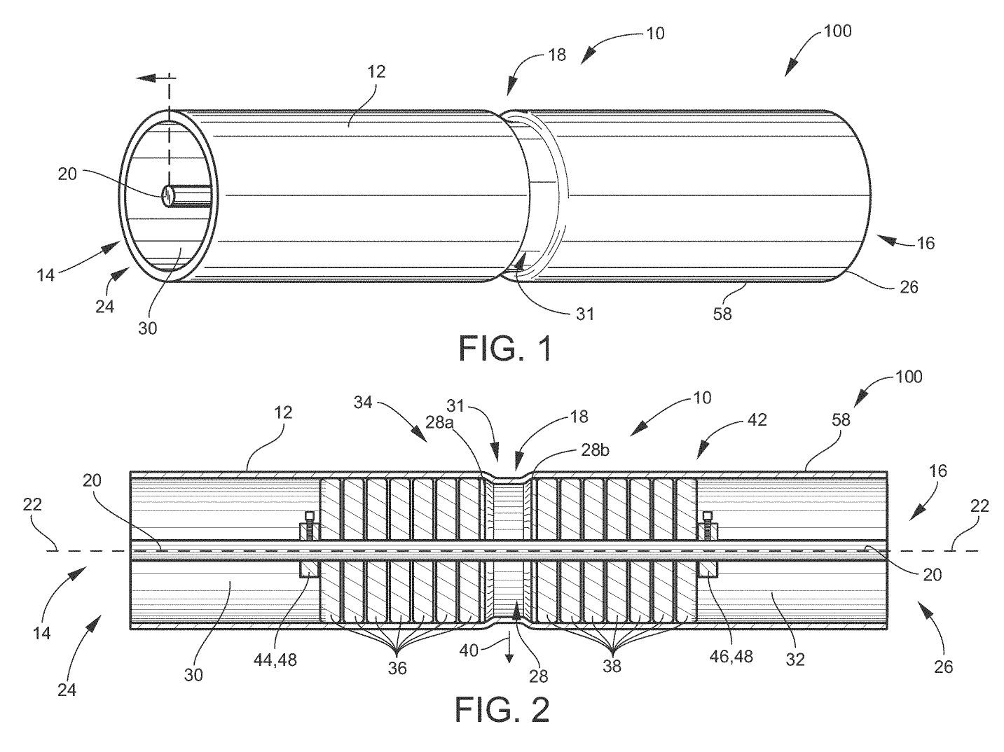

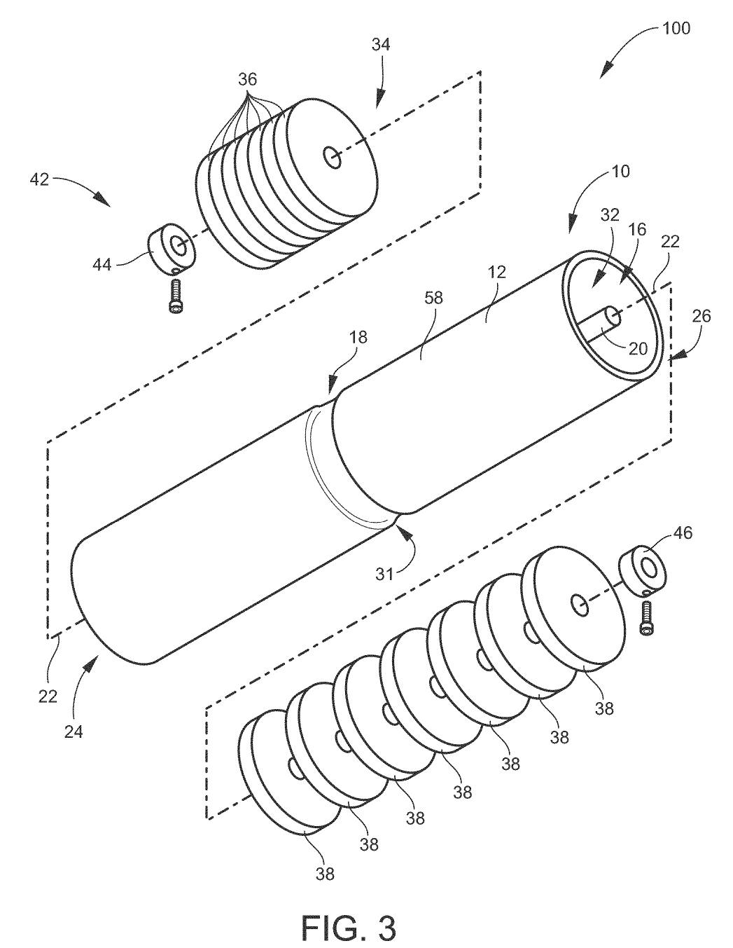

In describing the exemplary embodiments of the present disclosure, as illustrated in FIGS. 1-7, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples, and are merely examples among other possible examples.

Referring now to FIGS. 1-5, by way of example, and not limitation, therein is illustrated example embodiments of weight plate loadable body tempering device 10. Generally, weight plate loadable body tempering device 10 may include outer housing 12, shaft 20, and divider 28. These parts will be described in greater detail below.

Outer housing 12 may be included in weight plate loadable body tempering device 10. See FIGS. 1-5. Outer housing 12 may be for providing the shell or casing of the device with the outer surface that rolls on the user's body. As such, outer housing 12 may have a circular cross-section or substantially circular cross-section 58 for providing an outer rollable surface. Substantially circular cross-section 58 may mean that outer housing 12 may be a cylindrical shape or a substantially cylindrical shape or pipe with some recesses (like at middle 18) or even protrusions, if desired. In addition, outer housing 12 may include other various shapes, like oval cross-sections, hexagonal cross-sections, the like, etc. Outer housing 12 may include left opening 14, on one side, and right opening 16, on the other side (left and right designations will accordingly be used throughout based on the orientation in the figures, which can obviously be reversed). Left opening 14 may be separated from right opening 16 by divider 28, which may be positioned at the middle 18 of outer housing 12. As such, left weight chamber 30 may be formed in left opening 14 of outer housing 12 and right weight chamber 32 may be formed in right opening 16 of outer housing 12. In select embodiments, as shown in the Figures, outer housing 12 may be a single piece housing formed with left weight chamber 30 in left opening 14 and right weight chamber 32 in right opening 16, with divider 28 positioned therein. In other embodiments, outer housing 12 may be a multi-piece housing, like with one piece having left weight chamber 30 and the other piece having right weight chamber 32, where the two pieces are joined together approximate middle 18, like with divider 28.

Shaft 20 may be included in weight plate loadable body tempering device 10. See FIGS. 1-5. Shaft 20 may be for providing a means for centering or positioning the weight plates 34 inside the left and right weight chambers 30 and 32. Shaft 20 may extend through central axis 22 of outer housing 12 for centering the weight plates 34 inside the outer housing 12. Shaft 20 may extend from approximately left distal end 24 of left opening 14 to approximately right distal end 26 of right opening 16. In select embodiments, as shown in the figures, shaft 20 may be a single rod that extends from one end of the outer housing 12 to the other end. However, the disclosure is not so limited, and shaft 20 may be a multi piece shaft, like with one piece of shaft 20 in left weight chamber 30 and another piece of shaft 20 in right weight chamber 32. Shaft 20 may be sized and configured to match weight plates 34. For example, as shown in the figures, shaft 20 may have a circular cross-section for matching the diameter of the hole in donut-shaped weight plates 34.

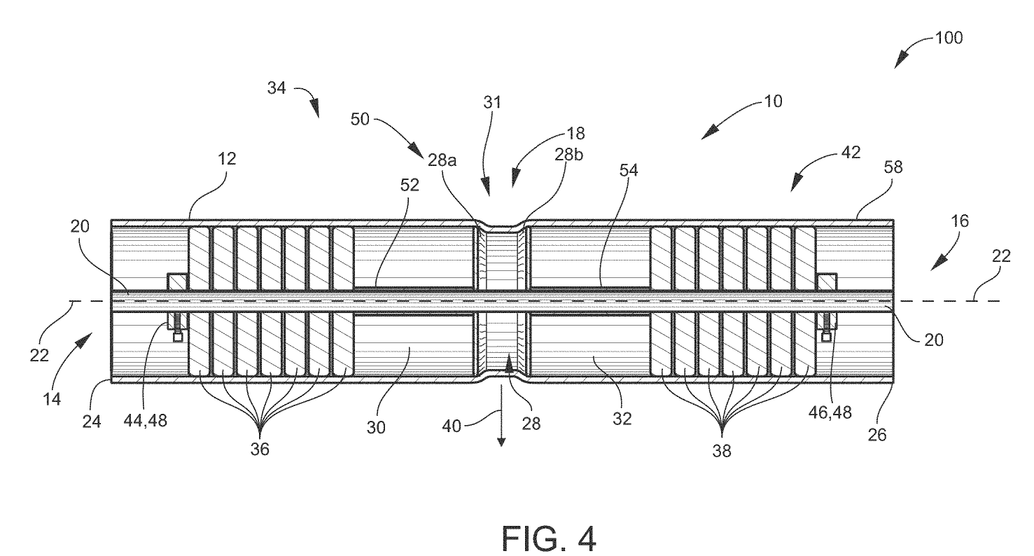

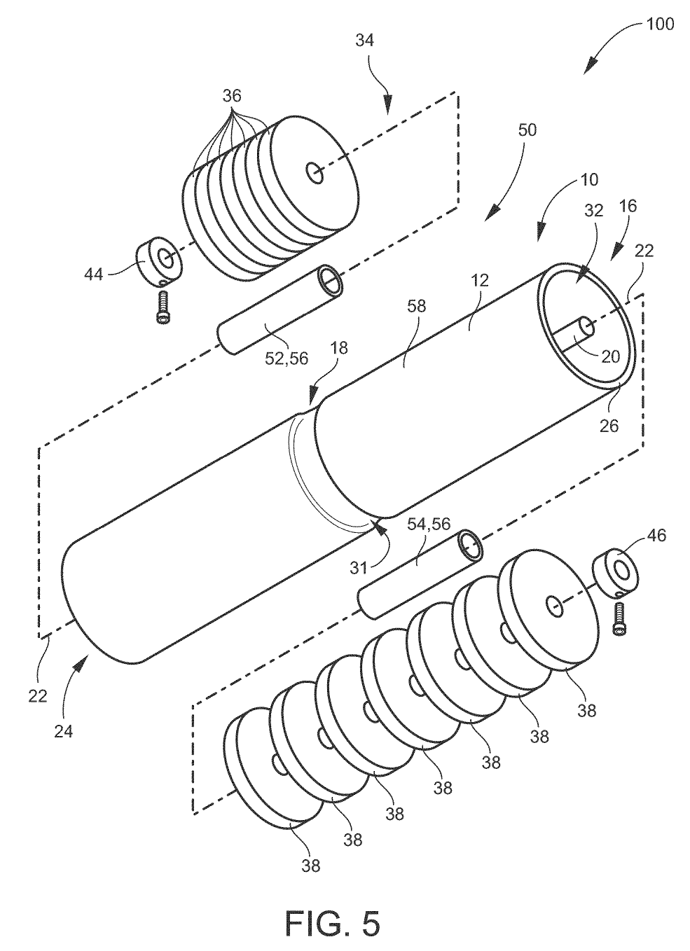

Divider 28 may be included in weight plate loadable body tempering device 10. See FIGS. 2 and 4. Divider 28 may be for separating left opening 14 from right opening 16, thereby forming left weight chamber 30 and right weight chamber 32 inside outer housing 12. Divider 28 may be positioned at middle 18 of outer housing 12 for making left weight chamber 30 equal to right weight chamber 32. Divider 28 may also be for positioning and holding/mounting shaft 20 on central axis 22 of outer housing 12. Divider 28 may include a left plate 28a and a right plate 28b. In select embodiments, as shown in the Figures, outer housing 12 may have an indention 31 around middle 18 for securing left plate 28a and right plate 28b inside outer housing 12 at the ends of left weight chamber 30 and right weight chamber 32, respectively. For example, this indention 31 in outer housing 12 may allow left plate 28a to be welded to one side of the indention 31 and right plate 28b to be welded to the other side of the indention 31.

Weight plates 34 may be included in weight plate loadable device 10 and system 100. See FIGS. 2, 3, 4 and 5. Weight plates 34 may be for providing adjustable total weight 40 of weight plate loadable device 10. Weight plates 34 may come in any size or shape configured to fit inside outer housing 12 and slide on shaft 20. For example, as shown in the figures, weight plates 34 may be donut-shaped weights, similar to standard barbell weights. Weight plates 34 may be included in system 100 as pairs for balancing the left weight chamber 30 with the right weight chamber 32. However, the disclosure is not so limited, and weight plates 34 may be individual weights that are added to weight plate loadable device 10, as desired. In select embodiments, each pair of the weight plates 34 may include a left weight plate 36 and a right weight plate 38. In these embodiments, the left weight plates 36 of each pair may be loadable on the shaft 20 in the left weight chamber 30 in the outer housing 12, and the right weight plates 38 of each pair may be loadable on the shaft 20 in the right weight chamber 38 in the outer housing 12. These pairs of weight plates 34 may allow weight plate loadable body tempering device 10 to have the adjustable total weight 40 by adjusting the number and/or size of the weight plates 34 loaded in the left and right weight chambers 30 and 32. In select embodiments, the left weight plate 36 may be the same size and/or weight of the corresponding right weight plate 38 in each of the corresponding left and right weight chambers 30 and 32 for each pair of the at least one pair of weight plates 34, thereby balancing the weight plate loadable body tempering device 10.

Clamps 42 may be included in weight plate loadable device 10 and system 100. See FIGS. 2, 3, 4 and 5. Clamps 42 may be for optionally securing weight plates 34 in left and right weight chambers 30 and 32 on shaft 20. Clamps 42 may come in any size or shape configured to fit inside outer housing 12 and lock on shaft 20. For example, as shown in the figures, clamps 42 may be compression clamping devices 48, similar to standard barbell clamps. Clamps 42 may be included in system 100 as pairs for securing weight plates 34 in both the left weight chamber 30 and the right weight chamber 32. However, the disclosure is not so limited, and clamps 42 may be individual clamps that are added to weight plate loadable device 10, as desired. In select embodiments, each pair of the clamps 42 may include a left clamp 44 and a right clamp 46. In these embodiments, the left clamp 44 of each pair may be configured to slide on shaft 20 in left opening 14 of outer housing 12 for holding the loaded left weight plates 36 in the left weight chamber 30 of outer housing 12, and right clamp 46 may be configured to slide on shaft 20 in the right opening 16 of the outer housing 12 for holding the loaded right weight plates 38 in the right weight chamber 32 of the outer housing 12. These pairs of clamps 42 may allow weight plate loadable body tempering device 10 to have the adjustable total weight 40 by quickly and easily securing weight plates 34 loaded in the left and right weight chambers 30 and 32.

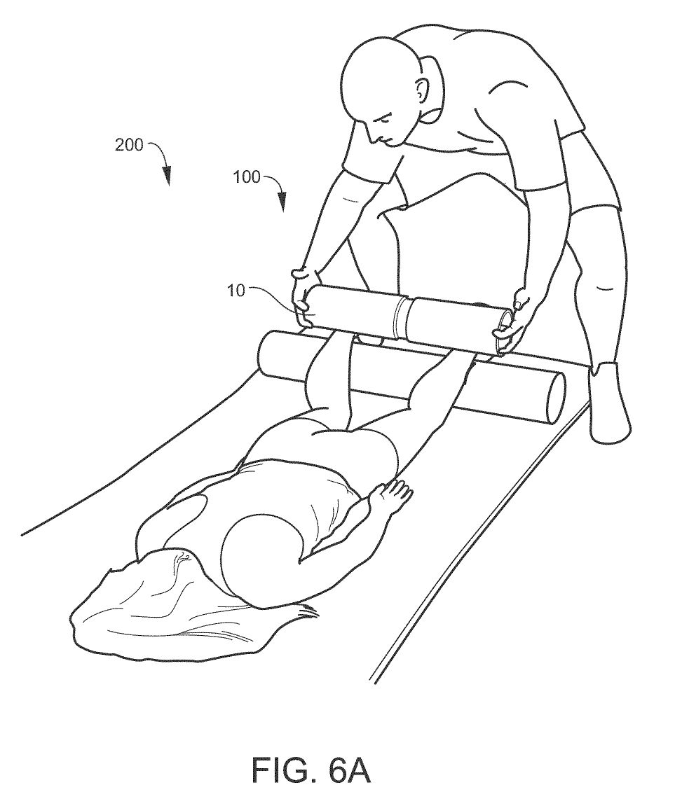

Spacers 50 may be included in weight plate loadable device 10 and system 100. See FIGS. 4 and 5. Spacers 50 may be for optionally spacing weight plates 34 from the middle 18 in left and right weight chambers 30 and 32 on shaft 20. Spacers 50 may come in any size or shape configured to fit inside outer housing 12 and space weight plates 34 from the middle 18. For example, as shown in the figures, spacers 50 may be cylinders 56 with an inner diameter configured to slide on shaft 20 and an outer diameter configured to prevent weight plates 34 from sliding past them. Spacers 50 may be included in system 100 as pairs for spacing weight plates 34 from the middle 18 in both the left weight chamber 30 and the right weight chamber 32. However, the disclosure is not so limited, and spacers 50 may be individual spacers, or multiple spacers used together that are added to weight plate loadable device 10, as desired to create the desired balance of weight in weight plate loadable device 10. In select embodiments, each pair of the spacers 50 may include a left spacer 52 and a right spacer 54. In these embodiments, the left spacer 52 of each pair may be configured slide on the shaft 20 in the left opening 14 of the outer housing 12 prior to loading the left weight plates 36 for spacing the subsequently loaded left weight plates 36 from the middle 18 in the left weight chamber 30. Various size left spacers 52 and or combinations of multiple left spacers 52 may be used for creating the desired spacing of loaded left weight plates 36 from the middle 18 in the left weight chamber 30. Also in these embodiments, the right spacer 54 of each pair may be configured slide on the shaft 20 in the right opening 16 of the outer housing 12 prior to loading the right weight plates 38 for spacing the subsequently loaded right weight plates 38 from the middle 18 in the right weight chamber 32. Various size right spacers 54 and or combinations of multiple right spacers 54 may be used for creating the desired spacing of loaded right weight plates 38 from the middle 18 in the right weight chamber 32. These pairs of spacers 50 may allow weight plate loadable body tempering device 10 to have the adjustable total weight 40 by quickly and easily spacing weight plates 34 from the middle in the left and right weight chambers 30 and 32, for creating a more balance weight distribution in weight plate loadable device 10.

Weight plate loadable body tempering system 100 is shown in FIGS. 1-6. Weight plate loadable body tempering system 100 may include weight plate loadable device 10 in any of the various embodiments shown and or described herein. System 100 may also include weight plates 34, clamps 42, spacers 50, the like, and/or any combinations thereof.

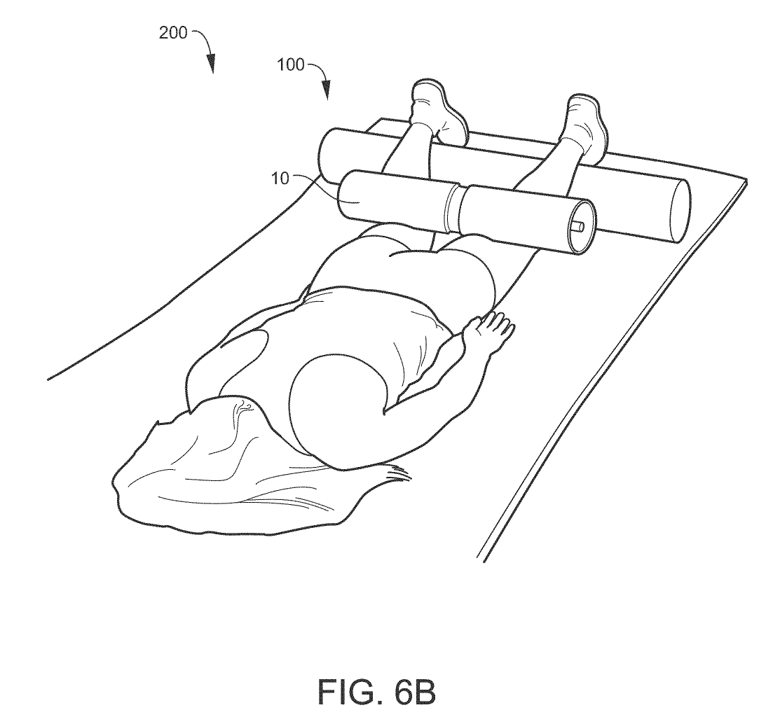

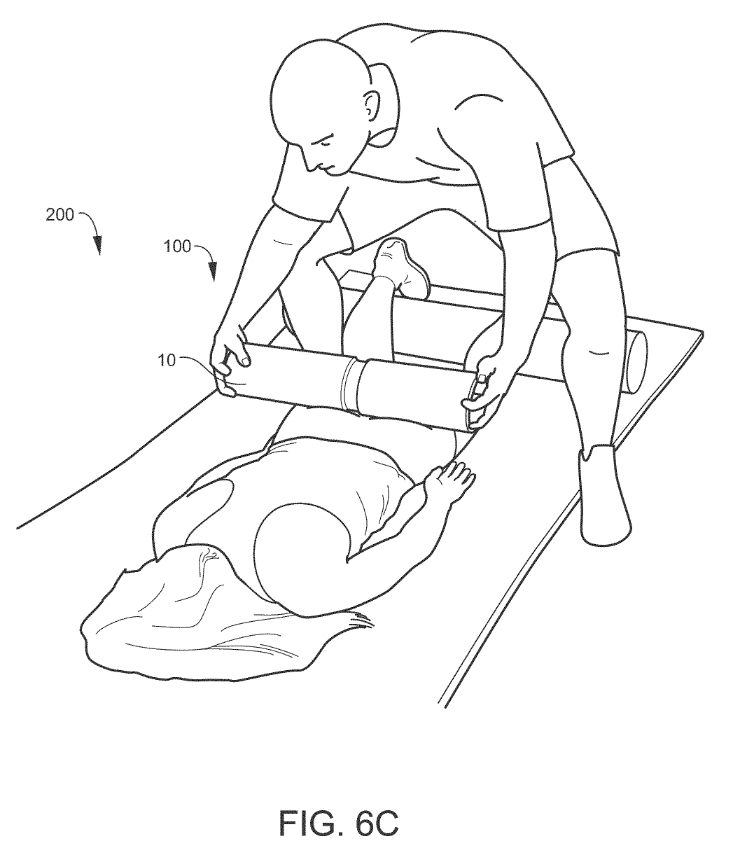

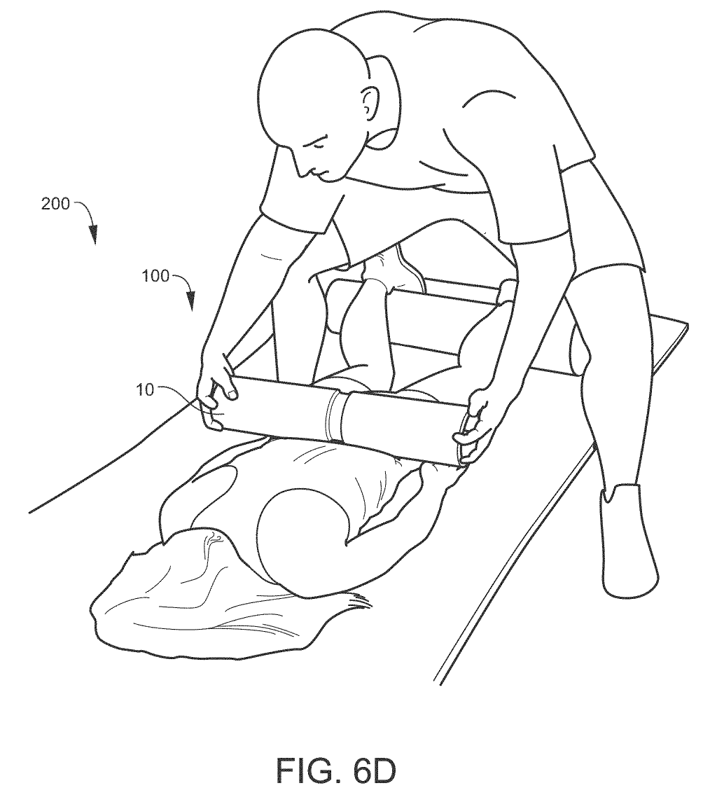

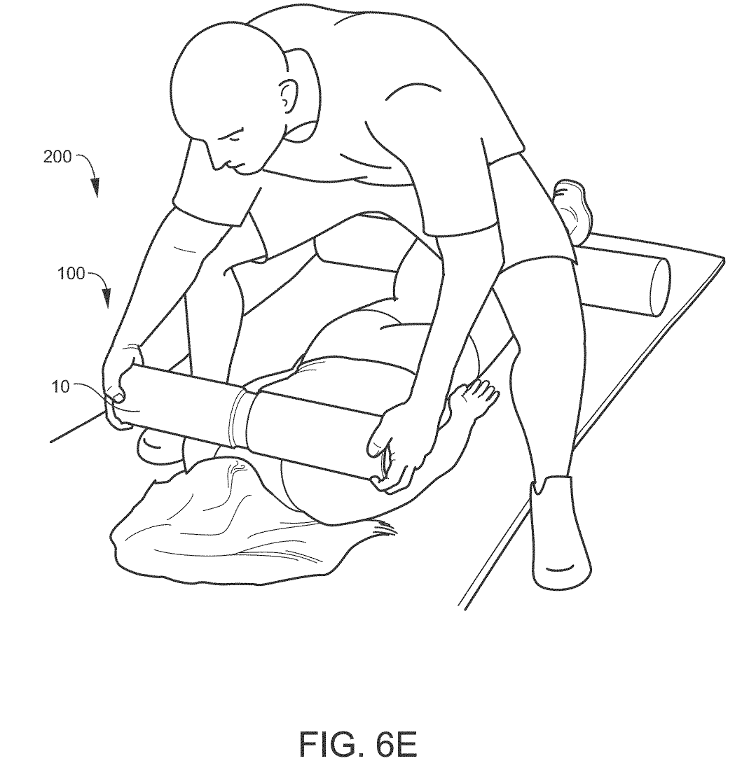

Referring now to FIGS. 6A-6E, weight plate loadable body tempering device 10 and/or system 100 may be used for body tempering by rolling outer housing 12 over one's body, similar to known heavy pipe body tempering devices. Body tempering device 10 and/or system 100 may be used in any means desired, including, but not limited to the example shown in FIGS. 6A-6E. In the example illustrated in FIGS. 6A-6E, body tempering device 10 is rolled down the body of a patient from the calves (FIG. 6A), to resting between the hamstrings and calves (FIG. 6B), to the glutes (FIG. 6C) to the lower back (FIG. 6D), and to the upper back (FIG. 6E). As device 10 may be rolled over the body, it is believed to break apart muscle adhesions and squeeze blood and water from the treated area. Once device 10 is removed from the treated area, the user's heart will flush the treated area with new blood. This new blood may rejuvenate the muscle tissue in the treated are thereby improving healing of the muscle tissue. As a result, body tempering with weight plate loadable device 10 is believed to help prevent hernias, tears, tweaks, muscle ruptures and protect against trauma, by allowing the body to work independently of muscle adhesions. As examples, body tempering with weight plate loadable device 10 may be used by athletes to help in strength training and recovery.

At any point prior to, during (like at the locations noted in FIGS. 6A, 6B, 6C, 6D, and/or 6E), or after this body tempering procedure, the adjustable total weight 40 of weight plate loadable body tempering device 10 may be easily adjusted by adjusting the amount and/or size of weight plates 34 loaded inside left weight chamber 30 and/or right weight chamber 32 of outer housing 12. As such, unlike known heavy fixed weight pipe like body tempering devices, weight plate loadable body tempering device 10 may be adjusted for providing different amounts of adjustable total weight 40. As such, weight plate loadable body tempering device 10 may have its adjustable total weight 40 quickly adjusted or changed for various areas of the body and for different sizes and shapes of people.

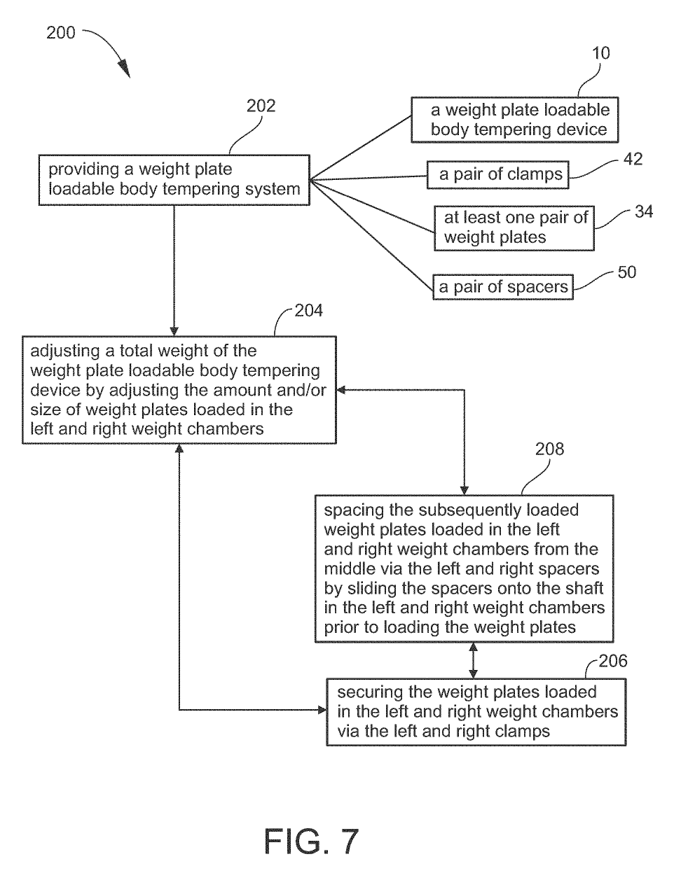

Referring now to FIG. 7, method 200 of adjustable body tempering is shown. Method 200 of adjustable body tempering may be for providing body tempering at various adjustable total weights 40 of weight plate loadable body tempering device 10. Method 200 may generally include the step of providing weight plate loadable body tempering system 100 in any of the various embodiments shown and/or described herein, including weight plate loadable device 10 in any of the various embodiments shown and/or described herein. As a result, method 200 of adjustable body tempering may include step 204 of adjusting total weight 40 of the weight plate loadable body tempering device 10 by adjusting the amount and/or size of weight plates 34 loaded in the left and right weight chambers 30 and 32.

In select embodiments, when weight plate loadable body tempering system 100 includes clamps 42, method 200 of adjustable body tempering may also include the step 206 of securing the weight plates 34 loaded in the left and right weight chambers 30 and 32 via the left and right clamps 44 and 46, respectively.

In other select embodiments, when weight plate loadable body tempering system 100 includes spacers 50, method 200 of adjustable body tempering may also include the step 208 of spacing the subsequently loaded weight plates 34 loaded in the left and right weight chambers 30 and 32 from the middle 18 via the left and right spacers 52 and 54, by sliding the spacers 52 and 54 onto the shaft 20 in the left and right weight chambers 30 and 32 prior to loading the weight plates 36 and 38, respectively.

The foregoing description and drawings comprise illustrative embodiments. Having thus described exemplary embodiments, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein, but is limited only by the following claims.

What is claimed is:

1. A weight plate loadable body tempering device comprising:
an outer housing having a left opening and a right opening separated by a middle;
a shaft extending through a central axis of the outer housing from approximately a left distal end of the left opening to approximately a right distal end of the right opening; and
a divider positioned inside the outer housing at the middle, the divider positioning the shaft on the central axis of the outer housing and separating the left opening from the right opening thereby creating a left weight chamber and a right weight chamber.

2. The weight plate loadable body tempering device of claim 1 further including:
at least one pair of weight plates configured to fit inside the outer housing and slide on the shaft, each pair of the at least one pair of weight plates including:
a left weight plate loadable on the shaft in the left weight chamber of the outer housing; and
a right weight plate loadable on the shaft in the right weight chamber of the housing.

3. The weight plate loadable body tempering device of claim 2 whereby the weight plate loadable body tempering device has an adjustable total weight by adjusting an amount and/or a size of the at least one pair of weight plates loaded in the left and right weight chambers.

4. The weight plate loadable body tempering device of claim 2, wherein each left weight plate is the same size and/or weight of the corresponding right weight plate for each pair of the at least one pair of weight plates thereby balancing the weight plate loadable body tempering device.

5. The weight plate loadable body tempering device of claim 2 further comprising:
a pair of clamps comprising:
a left clamp configured to slide on the shaft in the left opening of the outer housing for holding the loaded left weight plates in the left weight chamber of the outer housing; and
a right clamp configured to slide on the shaft in the right opening of the outer housing for holding the loaded right weight plates in the right weight chamber of the outer housing.

6. The weight plate loadable body tempering device of claim 5, wherein the pair of clamps being compression clamping devices.

7. The weight plate loadable body tempering device of claim 2 further comprising:
a pair of spacers comprising:
a left spacer configured to slide on the shaft in the left opening of the outer housing prior to loading the left weight plates for spacing the subsequently loaded left weight plates from the middle in the left weight chamber; and
a right spacer configured to slide on the shaft in the right opening of the outer housing prior to loading the right weight plates for spacing the subsequently loaded right weight plates from the middle in the right weight chamber.

8. The weight plate loadable body tempering device of claim 7, wherein the pair of spacers being cylinders.

9. The weight plate loadable body tempering device of claim 1, wherein the outer housing has a substantially circular cross-section.

10. A weight plate loadable body tempering system comprising:
a weight plate loadable device comprising an outer housing having a left weight chamber and a right weight chamber with a shaft extending through a central axis of the outer housing from approximately a left distal end of the left weight chamber to approximately a right distal end of the right weight chamber; and
at least one pair of weight plates configured to fit inside the outer housing and slide on the shaft, each pair of the at least one pair of weight plates including:
a left weight plate loadable on the shaft in the left weight chamber of the outer housing; and
a right weight plate loadable on the shaft in the right weight chamber of the housing.

11. The weight plate loadable body tempering system of claim 10 whereby the weight plate loadable body tempering device has an adjustable total weight by adjusting an amount and/or a size of the at least one pair of weight plates loaded in the left and right weight chambers.

12. The weight plate loadable body tempering device of claim 10, wherein each left weight plate is the same size and/or weight of the corresponding right weight plate for each pair of the at least one pair of weight plates thereby balancing the weight plate loadable body tempering device.

13. The weight plate loadable body tempering system of claim 10 further comprising:
a pair of clamps comprising:
a left clamp configured to slide on the shaft in the left weight chamber of the outer housing for holding the loaded left weight plates in the left weight chamber of the outer housing; and
a right clamp configured to slide on the shaft in the right weight chamber of the outer housing for holding the loaded right weight plates in the right weight chamber of the outer housing.

14. The weight plate loadable body tempering system of claim 10, wherein the pair of clamps being compression clamping devices.

15. The weight plate loadable body tempering system of claim 10 further comprising:
a pair of spacers comprising:
a left spacer configured to slide on the shaft in the left weight chamber of the outer housing prior to loading the left weight plates for spacing the subsequently loaded left weight plates from the middle in the left weight chamber; and
a right spacer configured to slide on the shaft in the right weight chamber of the outer housing prior to loading the right weight plates for spacing the subsequently loaded right weight plates from the middle in the right weight chamber.

16. The weight plate loadable body tempering system of claim 15, wherein the pair of spacers being cylinders.

17. The weight plate loadable body tempering system of claim 10, wherein the outer housing has a substantially circular cross-section.

18. A method of adjustable body tempering comprising:
providing a weight plate loadable body tempering system comprising:
a weight plate loadable device comprising an outer housing having a left weight chamber and a right weight chamber with a shaft extending through a central axis of the outer housing from approximately a left distal end of the left weight chamber to approximately a right distal end of the right weight chamber; and
at least one pair of weight plates configured to fit inside the outer housing and slide on the shaft, each pair of the at least one pair of weight plates including:
a left weight plate loadable on the shaft in the left weight chamber of the outer housing; and
a right weight plate loadable on the shaft in the right weight chamber of the housing;
adjusting a total weight of the weight plate loadable body tempering device by adjusting an amount and/or a size of weight plates loaded in the left and right weight chambers.

19. The method of adjustable body tempering of claim 18, wherein the weight plate loadable body tempering system further comprising:
a pair of clamps comprising:
a left clamp configured to slide on the shaft in the left weight chamber of the outer housing for holding the loaded left weight plates in the left weight chamber of the outer housing; and
a right clamp configured to slide on the shaft in the right weight chamber of the outer housing for holding the loaded right weight plates in the right weight chamber of the outer housing;
wherein, the method of adjustable body tempering further comprising the step of securing the weight plates loaded in the left and right weight chambers via the left and right clamps.

20. The method of adjustable body tempering of claim 18, wherein the weight plate loadable body tempering system further comprising:
a pair of spacers comprising:
a left spacer configured to slide on the shaft in the left weight chamber of the outer housing prior to loading the left weight plates for spacing the subsequently loaded left weight plates from the middle in the left weight chamber; and
a right spacer configured to slide on the shaft in the right weight chamber of the outer housing prior to loading the right weight plates for spacing the subsequently loaded right weight plates from the middle in the right weight chamber;
wherein, the method of adjustable body tempering further comprising the step of spacing the subsequently loaded weight plates loaded in the left and right weight chambers from the middle via the left and right spacers by sliding the spacers onto the shaft in the left and right weight chambers prior to loading the weight plates.
